(19) United States
(12) Patent Application Publication
(10) Pub. No.: US 2013/0191002 A1
(43) Pub. Date: Jul. 25, 2013

(54) DRIVE ASSIST SYSTEM AND DRIVE ASSIST METHOD

(71) Applicants: Yuki Minase, Susono-shi (JP); Koji Nakai, Susono-shi (JP)

(72) Inventors: Yuki Minase, Susono-shi (JP); Koji Nakai, Susono-shi (JP)

(73) Assignee: TOYOTA JIDOSHA KABUSHIKI KAISHA, Toyota-shi, Aichi-ken (JP)

(21) Appl. No.: 13/877,458

(22) PCT Filed: Oct. 12, 2011
(86) PCT No.: PCT/IB2011/002390

§ 371 Date: Apr. 3, 2013

(30) Foreign Application Priority Data
Oct. 13, 2010 (JP) 2010-230693

(51) Int. Cl. G06F 17/00

(52) U.S. Cl. CPC G06F 17/00
USPC 701/70

(57) ABSTRACT

A drive assist system includes: an acceleration change pattern setting portion that sets an acceleration change pattern of a vehicle that is a pattern of change in acceleration of the vehicle that occurs while the vehicle travels on a road; and a drive plan generating portion that generates a drive plan for the vehicle based on the acceleration change pattern set by the acceleration change pattern setting portion. The drive assist system generates a drive plan satisfying three conditions, namely, a kinetic model of the vehicle, a passing point of each corner, and an acceleration change pattern, using a solution to two-point boundary-value problems.

### BACKGROUND OF THE INVENTION

1. Field of the Invention

The invention relates to a drive assist system and a drive assist method that assist a driver in driving a vehicle.

2. Description of Related Art

There is available a conventional drive assist system that generates, through the use of an optimization method, a drive plan for causing a vehicle to turn a corner fastest as described in Theoretical Studies on Minimum-time Cornering Method, Transactions of Society of Automotive Engineers of Japan, Vol. 23 No. 2, April 1992, for example.

However, in the aforementioned related art, some drivers feel low riding comfort or difficulty in driving. Further, there is also an apprehension that drivers with poor driving skills may have difficulty in making a response. As a result, that is a possibility that appropriate drive assist is not provided.

### SUMMARY OF THE INVENTION

The invention provides a drive assist system and a drive assist method that make it possible to generate an appropriate drive plan and provide appropriate drive assist based on the drive plan.

A drive assist system according to one aspect of the invention is characterized by including an acceleration change pattern setting portion that sets an acceleration change pattern of a vehicle that is a pattern of change in acceleration of the vehicle that occurs while the vehicle travels on a road, and a drive plan generating portion that generates a drive plan for the vehicle based on the acceleration change pattern set by the Acceleration change pattern setting portion.

In this drive assist system, first of all, the pattern of change in acceleration that occurs while the vehicle travels on the road is set. At this moment, the acceleration change pattern is set according to, for example, a taste, driving skills, and the like of a driver. The drive plan for the vehicle is then generated based on the set acceleration change pattern. This use of the acceleration change pattern as well as a permissible acceleration (an upper limit) makes it possible to generate an appropriate drive plan taking the riding comfort, driving skills, and the like of each individual driver into consideration. Thus, it is possible to provide appropriate drive assist.

It is also appropriate to employ a configuration in which the drive assist system further includes a passing point setting portion that sets a passing point of the vehicle on the road and the drive plan generating portion generates the drive plan for the vehicle based on the acceleration change pattern set by the acceleration change pattern setting portion and the passing point set by the passing point setting portion.

The acceleration change pattern setting portion may set a plurality of the acceleration change patterns for sections of the road respectively, and select one of the plurality of the acceleration change patterns based on a driving condition of the vehicle on a preceding one of the sections of the road. In some cases, the acceleration change pattern cannot be determined in accordance with only the taste, driving skills, and the like of the driver. For example, when the vehicle enters a corner, there are three braking methods, namely, full-bore braking, non-full-bore, constant-G braking, and trail braking. Therefore, one of the acceleration change patterns that is suited for the braking method needs to be selected. For this reason, an acceleration change pattern is selected based on a driving condition (a speed and the like) for the vehicle on a preceding one of the sections of the road, thereby making it possible to generate a more appropriate drive plan.

The acceleration change pattern setting portion may set an acceleration change pattern according to a kinetic property of the vehicle. In this case, a drive plan closer to actual driving of the vehicle can be generated.

At this moment, the acceleration change pattern setting portion may set the acceleration change pattern such that a rate of change in acceleration decreases as an absolute value of the acceleration increases. In this case, the follow-up accuracy of the vehicle for the acceleration change pattern is enhanced in a region where the absolute value of the acceleration is large. Therefore, a drive plan can be generated with high accuracy even in the neighborhood of a limit of the acceleration.

Further, the acceleration change pattern setting portion may set the acceleration change pattern such that a rate of change in acceleration in a turning direction is small at the start of occurrence of the acceleration in the turning direction. In this case, the follow-up accuracy of the vehicle for the acceleration change pattern at the start of occurrence of the acceleration in the turning direction is enhanced. Therefore, a drive plan with a follow-up delay in steering taken into consideration can be generated.

Further, a drive assist system according to another aspect of the invention is characterized by holding time-series acceleration values of a vehicle and providing drive assist for the vehicle based on the time-series acceleration values.

By providing drive assist for the vehicle based on the time-series acceleration values of the vehicle, it becomes possible to appropriately provide drive assist such as evaluation of the driving of the driver, intervention control of the vehicle, and the like.

A drive assist method according to still another aspect of the invention includes setting an acceleration change pattern of a vehicle that is a pattern of change in acceleration of the vehicle that occurs while the vehicle travels on a road, and generating a drive plan for the vehicle based on the set acceleration change pattern.

It is also appropriate to employ a configuration in which the aforementioned drive assist method further includes setting a passing point of the vehicle on the road and the drive plan for the vehicle is generated based on the set acceleration change pattern and the set passing point.

In setting the acceleration change pattern, a plurality of acceleration change patterns may be set for sections of the road respectively, and one of the plurality of the acceleration change patterns may be selected based on a driving condition of the vehicle on a preceding one of the sections of the road.

The acceleration change pattern may be set according to a kinetic property of the vehicle.

In setting the acceleration change pattern, the acceleration change pattern may be set such that a rate of change in acceleration decreases as an absolute value of the acceleration increases.

In setting the acceleration change pattern, the acceleration change pattern may be set such that a rate of change in acceleration in a turning direction is small at the start of occurrence of the acceleration in the turning direction.

Further, a drive assist method according to still another aspect of the invention is characterized by holding time-series acceleration values of a vehicle and providing drive assist for the vehicle based on the time-series acceleration values.

The invention can provide a drive assist system and a drive assist method that make it possible to generate an appropriate drive plan and provide appropriate drive assist based on the drive plan.

### BRIEF DESCRIPTION OF THE DRAWINGS

Features, advantages, and technical and industrial significance of an exemplary embodiment of the invention will be described below with reference to the accompanying drawings, in which like numerals denote like elements, and wherein:

FIG. 1 is an overall configuration diagram showing one embodiment of a drive assist system according to the invention;

FIGS. 2A to 2C are conceptual diagrams exemplarily showing a kinetic model of a vehicle, a rule on passing points of the vehicle at a corner, and a rule on how to use a friction circle representing a change pattern of acceleration of the vehicle, respectively;

FIGS. 3A to 3G are conceptual diagrams each showing an acceleration model using a friction circle (a friction circle model);

FIGS. 4A and 4B are graphs showing examples of patterns of changing the accelerations of the acceleration models shown in FIGS. 3B and 3C, respectively;

FIG. 5 is a flowchart showing a processing procedure carried out by a condition setting portion shown in FIG. 1;

FIG. 6 is composed of conceptual diagrams showing an example of generating a drive plan;

FIG. 7 is composed of conceptual diagrams showing another example of generating a drive plan;

FIG. 8 is a flowchart showing details of a procedure of selecting an acceleration model in accordance with a driving condition on a road in the condition setting portion shown in FIG. 1;

FIGS. 9A to 9C are conceptual diagrams showing examples of rules on how to use friction circles using acceleration models suited for full-bore braking, non-full-bore, constant-G braking, and trail braking, respectively;

FIG. 10 is a graph showing a relationship between a driving condition on a preceding corner (an exit position and an exit speed) and a braking pattern;

FIG. 11 is composed of graphs showing a preferred method of changing a longitudinal acceleration Gx and a lateral acceleration Gy;

FIG. 12 is composed of graphs showing a preferred method of changing the lateral acceleration Gy through steering in entering a corner; and

FIGS. 13A and 13B are diagrams showing a method of evaluating the driving of a driver using a time-series evaluation acceleration values of the vehicle.

### DETAILED DESCRIPTION OF EMBODIMENT

An embodiment of a drive assist system according to the invention will be described hereinafter in detail with reference to the drawings.

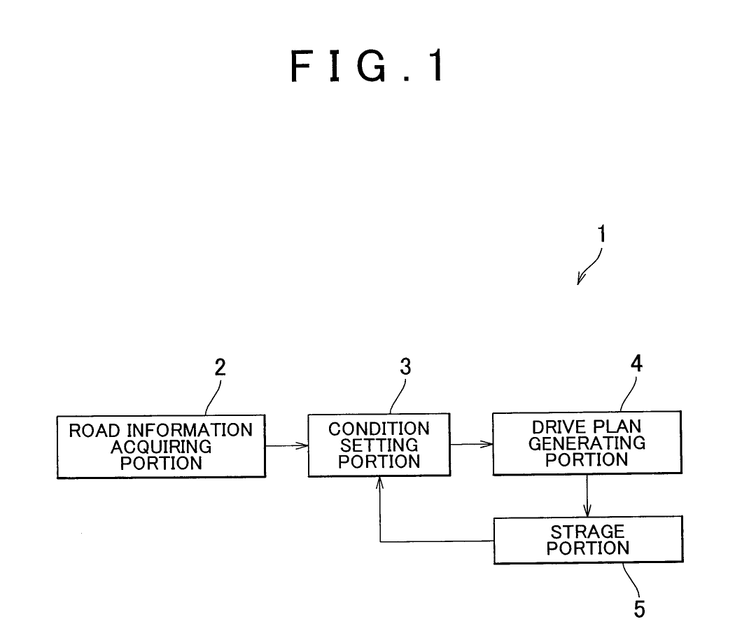

FIG. 1 is an overall configuration diagram showing one embodiment of a drive assist system according to the invention. In FIG. 1, a drive assist system 1 of this embodiment of the invention is a device that generates a drive plan (a locus) for a vehicle in an arbitrary section (a corner in this case) of a road on which the vehicle travels and provides support for the driving of the vehicle.

The drive assist system 1 has a road information acquiring portion 2, a condition setting portion 3, a drive plan generating portion 4, and a storage portion 5. The road information acquiring portion 2 acquires information on the shape and the like of a road on which the vehicle is about to travel. The road information acquiring portion 2 acquires, for example, information on navigation.

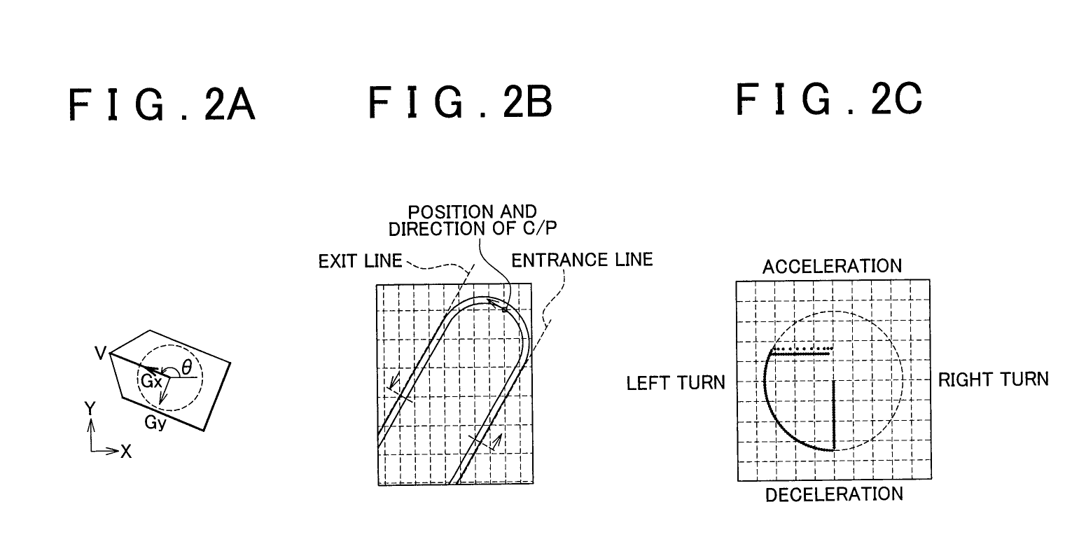

The condition setting portion 3 sets conditions needed to generate a drive plan for the vehicle. As shown in FIG. 2, there are three conditions needed to generate the drive plan for the vehicle, namely, a kinetic model of the vehicle, a rule on passing points (lines) of the vehicle at a corner, and a rule on how to use (how to move a point in) a friction circle representing a time-series change pattern of an acceleration of the vehicle.

As shown in FIG. 2A, parameters of the kinetic model of the vehicle are position coordinates x, y (e.g., a latitude and a longitude) of the vehicle, an angle 0 of inclination of the vehicle with respect to a reference coordinate axis, a vehicle speed V of the vehicle, a longitudinal acceleration Gx of the vehicle, and a lateral acceleration Gy of the vehicle.

As shown in FIG. 2B, the passing points of the vehicle at the corner are a clipping point (C/P), an arbitrary point on an entrance line, and an arbitrary point on an exit line. Positions and directions of these three points are then selected.

As shown in FIG. 2C, an axis of ordinate indicates an acceleration amount and a deceleration amount (corresponding to the longitudinal acceleration Gx), and an axis of abscissa indicates a left turn amount and a right turn amount (corresponding to the lateral acceleration Gy).

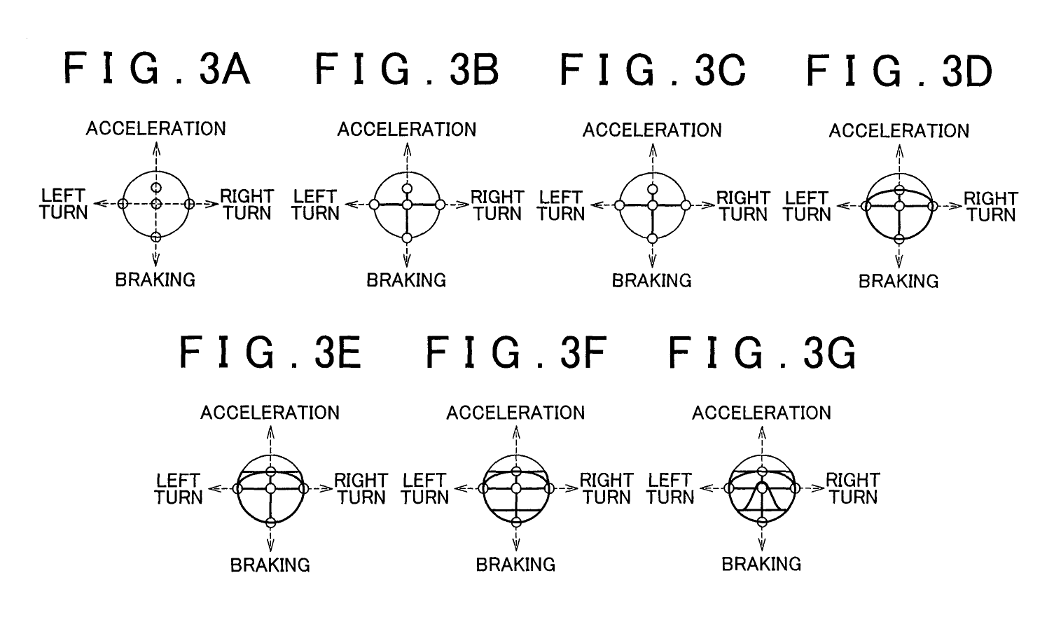

As shown in FIGS. 3A to 3G, there are a plurality of acceleration models (friction circle models) each using such a friction circle. These acceleration models are stored in advance in the aforementioned storage portion 5.

The acceleration model shown in FIG. 3A is constructed by simply combining five fixed points, namely, a zero-acceleration point (an origin), an acceleration point, a deceleration point, a left turn point, and a right turn point, with one another. In this acceleration model, since movements among the respective fixed points are instantaneously made, a basic drive plan can be generated. Further, this acceleration model makes it possible to analytically obtain a drive plan, and is therefore useful also as initial solutions to other acceleration models requiring numerical calculation.

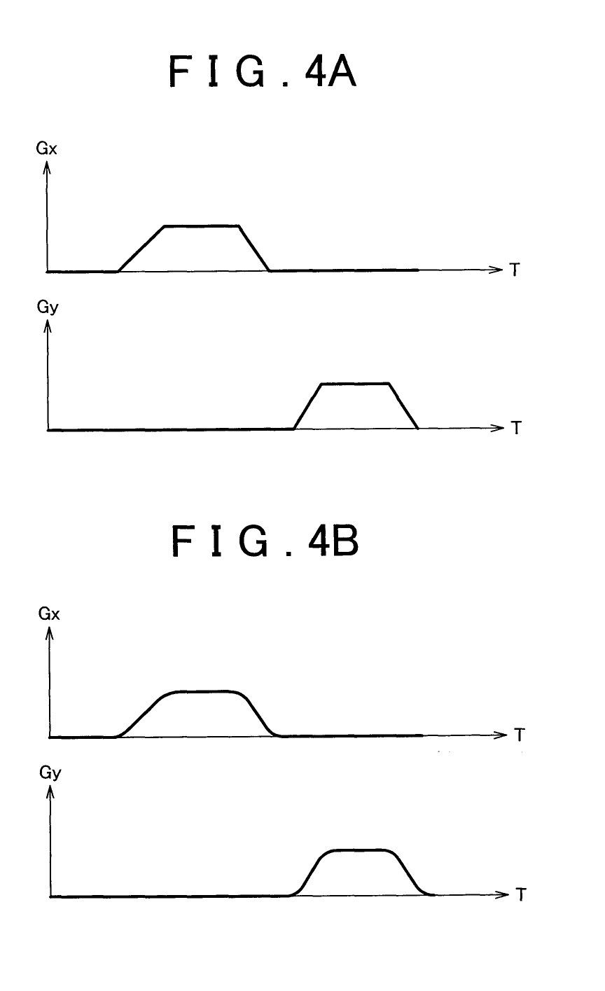

In the acceleration model shown in FIG. 3B, movements among the respective fixed points are made not instantaneously, but over a certain time to ensure the continuity of the acceleration as shown in FIG. 4A. However, there is a condition that one of the longitudinal acceleration Gx and the lateral acceleration Gy be 0 when the other is changing. This acceleration model is more complicated in calculation than the acceleration model shown in FIG. 3A. However, due to the continuity of the acceleration, a highly practicable drive plan can be generated.

In the acceleration model shown in FIG. 3C, when movements among the respective fixed points are made, the continuity of the first derivative of the acceleration (jerk) as well as the continuity of the acceleration is ensured as shown in FIG. 4B. In this acceleration model, a very highly practicable and smooth drive plan can be generated.

In the acceleration model shown in FIG. 3D, the restriction that one of the longitudinal acceleration Gx and the lateral acceleration Gy is 0 when the other is changing is eliminated, and movements are made along an ellipse passing an acceleration point, a left turn point, and a right turn point on an acceleration side, and along a circle passing a deceleration point, the left turn point, and the right turn point on a braking side. In this acceleration model, an efficient drive plan with a short arrival time can be generated.

In the acceleration model shown in FIG. 3E, a straight line is added in addition to the ellipse on the acceleration side in the acceleration model shown in FIG. 3D. In this acceleration model, although calculation is complicated, a drive plan with the performance of tires and the vehicle brought out to its limit can be generated.

In the acceleration model shown in FIG. 3F, a straight line is added to the acceleration model shown in FIG. 3E on a deceleration side (on a braking side). In this acceleration model, although calculation is complicated, a drive plan that requires only a small deceleration amount and ensures high efficiency at a corner can be generated.

In the acceleration model shown in FIG. 3G, it is made possible to start deceleration and a turn at the same time during a process of deceleration in the acceleration model shown in FIG. 3F. In this acceleration model, a drive plan that requires only a small deceleration amount and ensures higher efficiency at a corner can be generated.

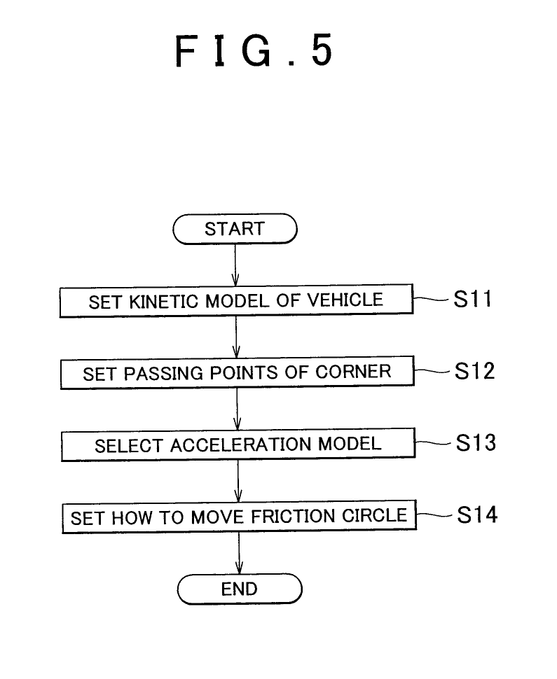

FIG. 5 is a flowchart showing a processing procedure carried out by the condition setting portion 3. In FIG. 5, first of all, a kinetic model of the vehicle as shown in FIG. 2A is set (a procedure S11). Subsequently, passing points (see FIG. 2B) of each corner at which the vehicle is about to travel are set from a shape of a road acquired by the road information acquiring portion 2 (a procedure S12).

Subsequently, among the plurality of the acceleration models stored in the storage portion 5 (see FIGS. 3A to 3G), one of the acceleration models that is suited for a driver is selected (a procedure S13). For example, a computer of the vehicle automatically selects the acceleration model by making a determination based on a result obtained by learning a driving style (driving skills, a taste, a habit and the like) of the driver in the past. For example, one of the acceleration models shown in FIGS. 3A to 3C is selected so as not to perform an acceleration/deceleration operation and a turning operation at the same time when a beginner drives the vehicle, and one of the acceleration models shown in FIGS. 3D to 3G is selected so as to smoothly perform an acceleration/deceleration operation and a turning operation when an experienced driver drives the vehicle. It should be noted that the driver himself or herself may select one of the acceleration models.

Subsequently, using the acceleration model selected in the procedure S13, a target value pattern (an acceleration change pattern) for changing the acceleration of the vehicle with time during a driving process at a corner is set based on data on the passing points of the corner set in the procedure S12 (a procedure S14). That is, a rule on how to move the point in a friction circle (how to use the friction circle) in the selected acceleration model is determined.

Returning to FIG. 1, the drive plan generating portion 4 generates, using a solution to a boundary value problem, a drive plan satisfying three conditions, namely, the kinetic model of the vehicle, the passing points of each corner, and the acceleration change pattern (the rule on how to move the point in the friction circle), set by the aforementioned condition setting portion 3. The drive plan generating portion 4 then stores the drive plan into the storage portion 5.

Hereinbefore, the aforementioned procedure S12 of the condition setting portion 3 is a component of the passing point setting portion that sets the passing point of the vehicle on the road. The procedures S13 and S14 are components of the acceleration change pattern setting portion that sets the acceleration change pattern of the vehicle during the process of driving of the vehicle on the road. The drive plan generating portion 4 is a component of the drive plan generating portion that generates the drive plan of the vehicle using the acceleration change pattern set by the acceleration change pattern setting portion.

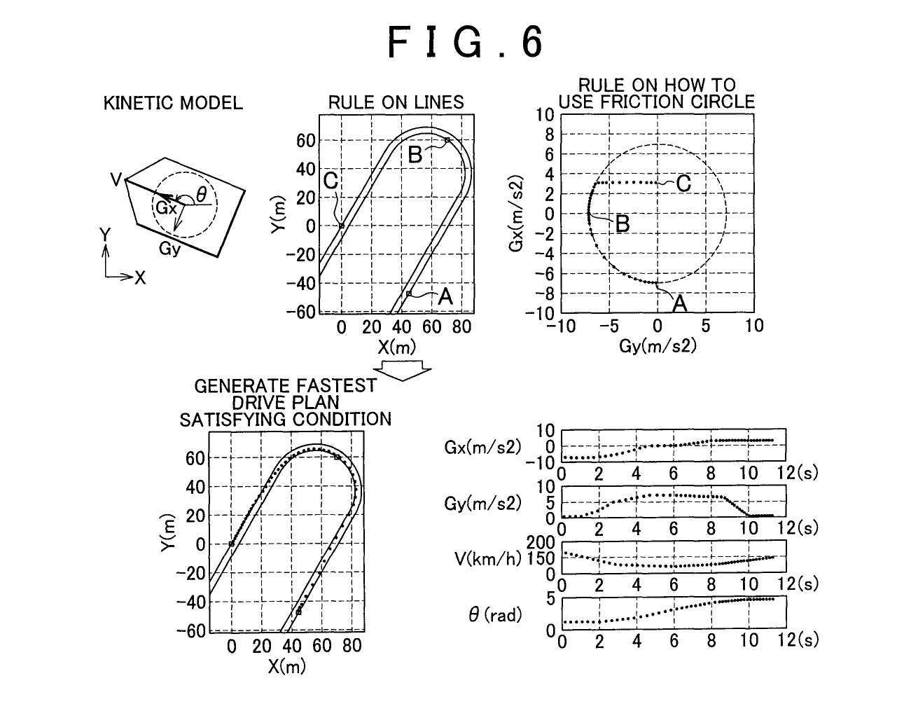

FIG. 6 shows an example of generating a drive plan. In this example, a drive plan is generated such that the vehicle is caused to turn a left corner at a highest speed, and the acceleration model shown in FIG. 3E is used.

In this case, an acceleration change pattern is set such that the vehicle, which has traveled straight at an arbitrary speed, is decelerated at a maximum deceleration at an entrance point A of the corner, that the left turn amount of the vehicle is maximized and the longitudinal acceleration of the vehicle is made equal to 0 at a clipping point B of the corner, and that the vehicle is accelerated at a predetermined acceleration and caused to travel straight at an exit point C of the corner. A drive plan is then generated such that the longitudinal acceleration Gx, the lateral acceleration Gy, the vehicle speed V, and the angle θ of inclination change with time as shown in the graph of FIG. 6.

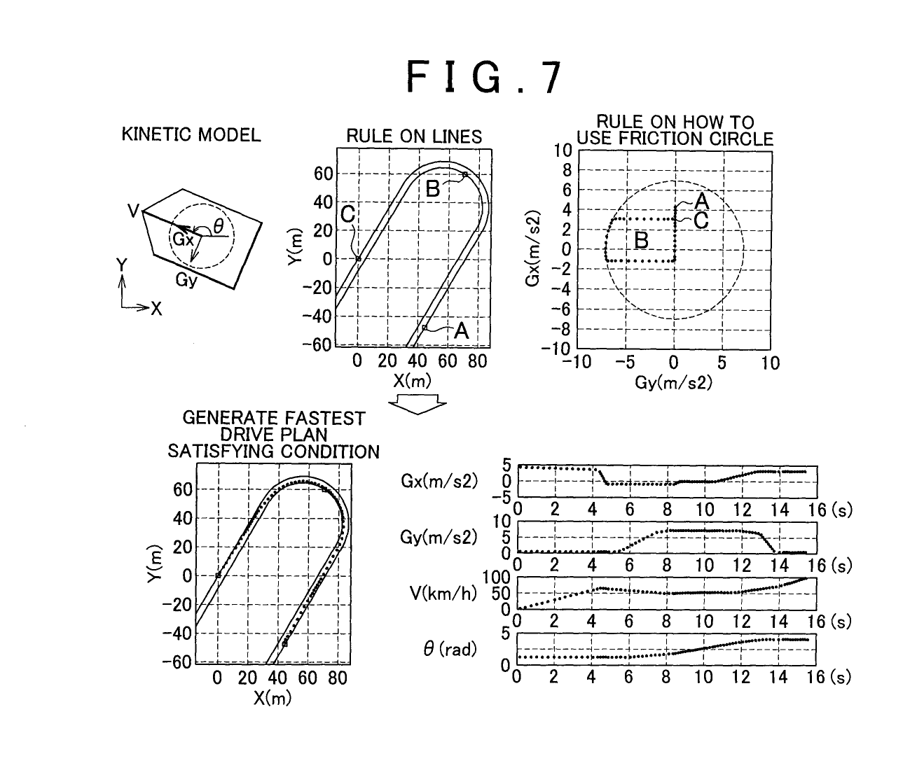

FIG. 7 shows another example of generating a drive plan. In this example, a drive plan is generated such that the vehicle is caused to turn a left corner at a highest speed as in the example shown in FIG. 6, and the acceleration model shown in FIG. 3F is used.

In this case, an acceleration change pattern is set such that the vehicle starts to be decelerated at the entrance point A of the corner, that the left turn amount of the vehicle is maximized and the longitudinal acceleration of the vehicle is made equal to 0 at the clipping point B of the corner, and that the vehicle is accelerated at a predetermined acceleration and caused to travel straight at the exit point C of the corner. A drive plan is then generated such that the longitudinal acceleration Gx, the lateral acceleration Gy, the vehicle speed V, and the angle θ of inclination change with time as shown in the graph of FIG. 7.

As described above, in this embodiment of the invention, the kinetic model of the vehicle, the passing points of each corner, and the acceleration change pattern (the rule on how to move the point in the friction circle) are set, and the drive plan satisfying these conditions is generated. In this case, the acceleration model used to set the acceleration change pattern is selected in accordance with the driving of each individual driver. Thus, the acceleration change pattern is also set in accordance with the driving of each individual driver. For example, the acceleration change pattern is set completely differently depending on whether a beginner or a racing driver drives the vehicle. Thus, an optimal drive plan based on the riding comfort, the driving skills, and the like of each individual driver can be generated.

On the contrary, the driving style of the driver can be classified by referring to such a drive plan, and it is made possible to determine, for example, the driving skills of the driver.

Further, in the case where vehicle stability control (VSC) is activated when the vehicle is running, for example, even a driver with poor driving skills, who has already become incapable of making a response, can continue to drive appropriately depending on the driving skills by being provided with drive assist according to the generated drive plan.

Although the preferred embodiment of the drive assist system according to the invention has been described above, the invention can be modified without departing from the gist thereof. Modifications of the foregoing embodiment of the invention will be described hereinafter.

In the foregoing embodiment of the invention, an appropriate one of the acceleration models is selected based on the driving behavior of the driver according to the taste, the driving skills, and the like of the driver. However, an appropriate one of the acceleration models may also be selected in accordance with a driving condition on a road instead of the driving behavior of the driver.

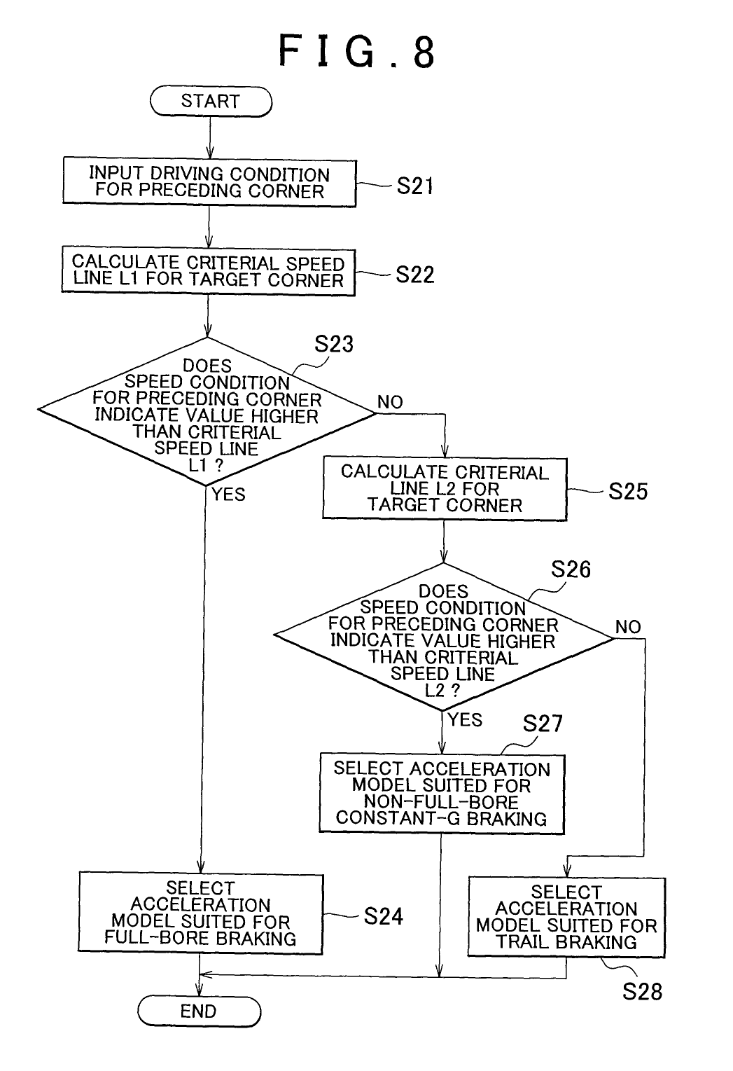

FIG. 8 is a flowchart showing details of a procedure of selecting an acceleration model in accordance with a driving condition on a road in the aforementioned condition setting portion 3.

In FIG. 8, first of all, a driving condition on a corner (hereinafter referred to as a preceding corner) immediately before a corner considered to be a target (hereinafter referred to as a target corner) is input (a procedure S21). The driving condition on the preceding corner includes an exit position of the vehicle at the preceding corner and an exit speed of the vehicle at the preceding corner. It should be noted that the driving condition on the preceding corner is obtained from, for example, an already generated drive plan for the preceding corner.

Subsequently, a criterial speed line L1 for the target corner is calculated (a procedure S22). The criterial speed line L1 means a speed line in a case where full-bore braking is applied momentarily. Subsequently, it is determined whether or not the speed condition for the preceding corner indicates a value higher than the criterial speed line L1 (a procedure S23).

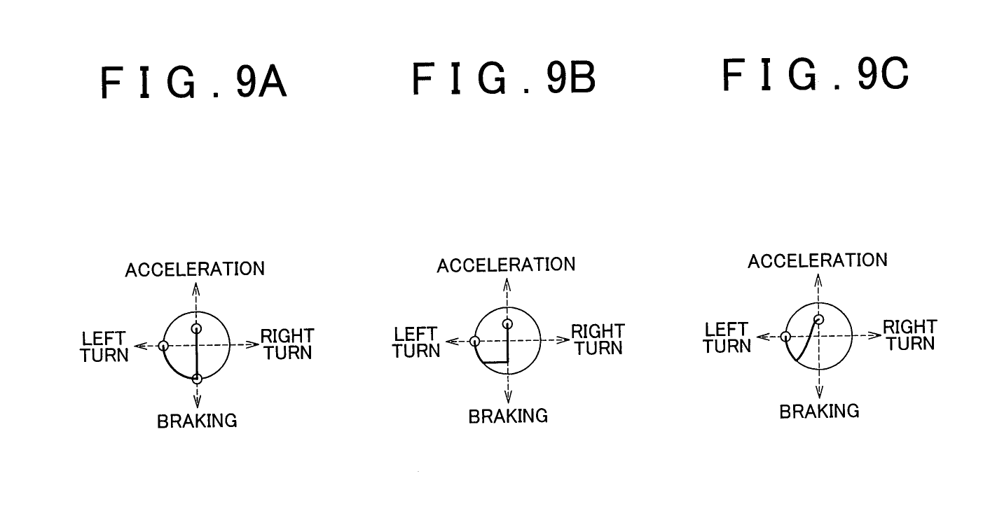

When it is determined that the speed condition for the preceding corner indicates a value higher than the criterial speed line L1, an acceleration model suited for full-bore braking is selected (a procedure S24). The acceleration model suited for full-bore braking is a model as shown in FIG. 3D. Using this acceleration model, an acceleration change pattern (a rule on how to move the point in a friction circle) for turning the target corner while performing full-bore braking is then set as shown in FIG. 9A.

When it is determined in the procedure S23 that the speed condition for the preceding corner indicates a value equal to or lower than the criterial speed line L1, a criterial speed line L2 for the target corner is calculated (a procedure S25). The criterial speed line L2 means a speed line in a case where the rate of increase in braking force is raised to the limit of vehicle response in trail braking. Subsequently, it is determined whether or not the speed condition for the preceding corner indicates a value higher than the criterial speed line L2 (a procedure S26).

When it is determined that the speed condition for the preceding corner indicates a value higher than the criterial speed line L2, an acceleration model suited for non-full-bore, constant-G braking is selected (a procedure S27). The acceleration model suited for non-full-bore constant-G braking is a model as shown in FIG. 3F. Using this acceleration model, an acceleration change pattern for turning the target corner while performing non-full-bore constant-G braking is then set as shown in FIG. 9B.

When it is determined in the procedure S26 that the speed condition for the preceding corner indicates a value equal to or lower than the criterial speed line L2, an acceleration model suited for trail braking is selected (a procedure S28). The acceleration model suited for trail braking is a model as shown in FIG. 3G. Using this acceleration model, an acceleration change pattern for turning the target corner while performing trail braking is then set as shown in FIG. 9C.

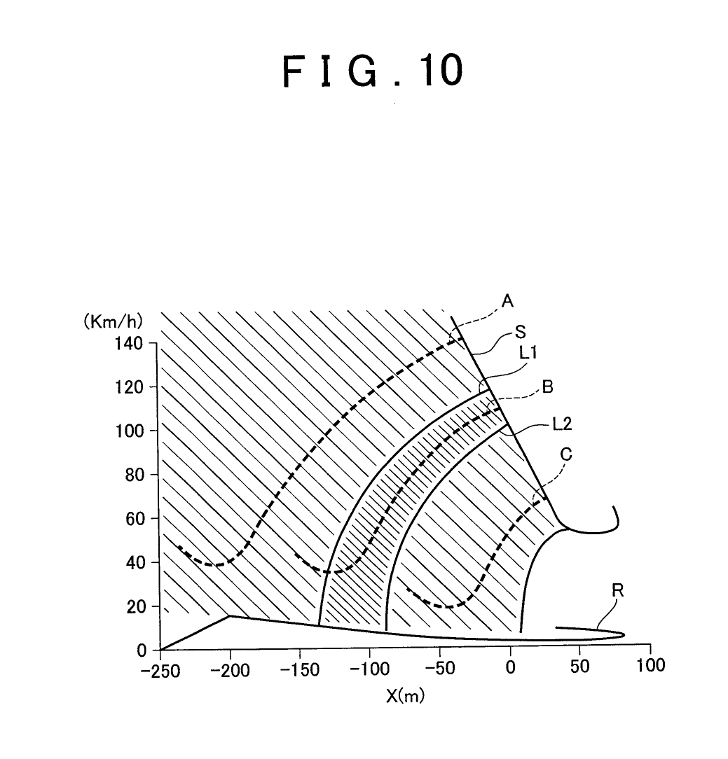

FIG. 10 is a graph showing a relationship between the driving condition (the exit position and the exit speed) for the preceding corner and a braking pattern. A solid line R in FIG. 10 schematically represents the shape of a road on which the vehicle travels. An axis of abscissa of the graph represents a position of the road in an x-axis direction, and an axis of ordinate of the graph represents a speed of the vehicle. Further, each of broken lines A to C in FIG. 10 represents a driving condition on the preceding corner, and a solid line S in FIG. 10 represents an entrance limit speed.

In a driving situation as indicated by the broken line A, since the exit position of the preceding corner is far from the target corner, the speed is higher than the criterial speed line L1. Thus, it is necessary for the vehicle to enter the target corner after applying full-bore braking. Accordingly, as shown in FIG. 9A, an acceleration change pattern is set using the acceleration model suited for full-bore braking.

In a driving situation indicated by the broken line B, the exit position of the preceding corner is a little distant from the target corner, and the speed is between the criterial speed line L1 and the criterial speed line L2. In this case, the vehicle may enter the target corner after applying non-full-bore, constant-G braking. Accordingly, as shown in FIG. 9B, an acceleration change pattern is set using the acceleration model suited for non-full-bore, constant-G braking.

In a driving situation indicated by the broken line C, since the exit position of the preceding corner is relatively close to the target corner, the speed is lower than the criterial speed line L2. In this case, the vehicle can pass the target corner while applying trail braking. Accordingly, as shown in FIG. 9C, an acceleration change pattern is set using the acceleration model suited for trail braking.

In this modification, an optimal acceleration model in entering the target corner is selected based on a distance (a traveling distance) between the target corner and the preceding corner and an exit speed at the preceding corner, and an acceleration change pattern is set using the acceleration model. Therefore, a more appropriate drive plan can be generated.

Meanwhile, although the longitudinal acceleration Gx and the lateral acceleration Gy may be changed with a constant jerk in setting an acceleration change pattern (a rule on how to move the point in a friction circle), it is desirable to change the longitudinal acceleration Gx and the lateral acceleration Gy in the following manner.

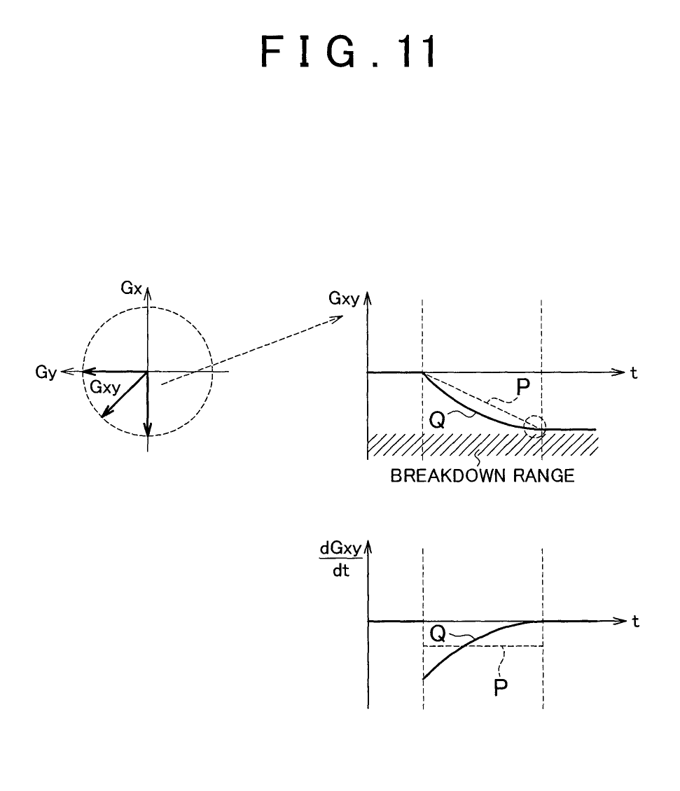

FIG. 11 is composed of graphs showing a preferred method of changing the longitudinal acceleration Gx and the lateral acceleration Gy. When the longitudinal acceleration Gx and the lateral acceleration Gy (a vector sum Gxy of Gx and Gy) are changed with a constant jerk as indicated by broken lines P in FIG. 11 in moving the point in a friction circle, the derivative of the jerk is discontinuous in a range where the longitudinal acceleration Gx and the lateral acceleration Gy are large. Therefore, the follow-up accuracy of the vehicle deteriorates. In the worst case, there is a possibility that the limit of the friction circle is exceeded and the friction circle becomes inapplicable.

For this reason, as indicated by solid lines Q in FIG. 11, the friction circle is slowly moved such that the jerk (the rate of change in the acceleration) decreases as the magnitude of the longitudinal acceleration Gx and the magnitude of the lateral acceleration Gy increase. Thus, the follow-up accuracy of the vehicle is enhanced as the limit of the friction circle is approached, and the risk of the friction circle becoming inapplicable can be reduced. As a result, a drive plan can be generated with high accuracy in the neighborhood of the limit of the friction circle.

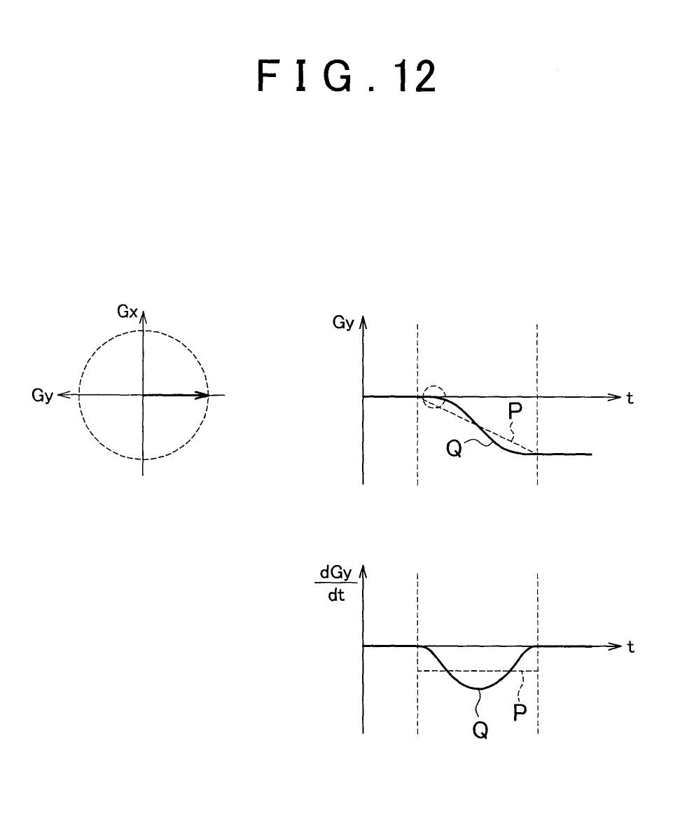

FIG. 12 is composed of graphs showing a preferred method of changing the lateral acceleration Gy through steering in entering a corner. When a steering wheel is operated, the lateral acceleration Gy does not rise immediately, but force transmission occurs in the order of a front-wheel cornering force, a yaw moment, a rear-wheel cornering force, and the lateral acceleration Gy. Therefore, the initial rising of the lateral acceleration Gy is delayed. Thus, as indicated by broken lines P in FIG. 12, in the case where the lateral acceleration Gy is changed with a constant jerk, the follow-up accuracy of the vehicle deteriorates during the initial rising of the lateral acceleration Gy.

For this reason, as indicated by solid lines Q in FIG. 12, the point in the friction circle is slowly moved such that the jerk (the rate of change in the acceleration) decreases during the initial rising of the lateral acceleration Gy. Thus, the follow-up accuracy of the vehicle is enhanced. As a result, a drive plan with a follow-up delay in steering taken into account can be generated.

It should be noted that the drive assist system of the invention is not limited to the foregoing embodiment of the invention and the modifications thereof. For example, although the acceleration change pattern (the rule on how to move the point in the friction circle) is set such that the acceleration is changed with time in the foregoing embodiment of the invention and the modifications thereof, the invention is not limited thereto in particular. It is also appropriate to set a pattern of changing the acceleration in accordance with the distance, a pattern of changing the acceleration in accordance with the ratio between the time and the distance, and the like.

Further, although the drive plan for the vehicle is generated in the foregoing embodiment of the invention and the modifications thereof, the invention is not limited thereto in particular. It is also possible to hold time-series acceleration values of the vehicle in advance and provide drive assist based on the time-series acceleration values.

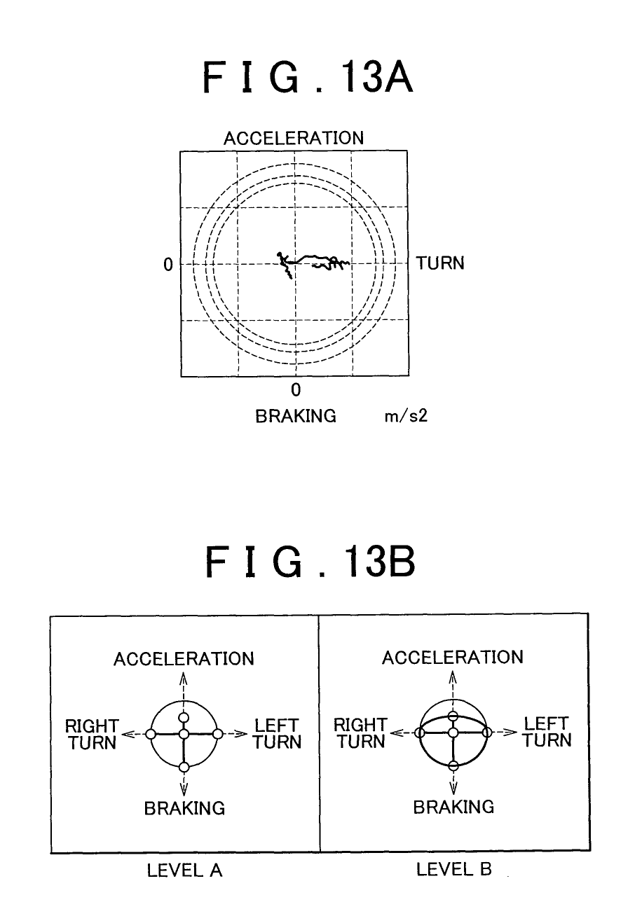

More specifically, time-series evaluation acceleration values (an acceleration model) of the vehicle are held, and an acceleration change pattern measured during the actual driving of the vehicle is compared with the evaluation acceleration values to evaluate the driving of a driver. For example, as shown in FIG. 13, an acceleration change pattern during actual driving (see FIG. 13A) is compared with an evaluation acceleration value (see FIG. 13B), and a level A, which corresponds to the evaluation acceleration values having a pattern closest to the acceleration change pattern during actual driving, is determined to be the level of the driving skills of the driver.

Further, it is also possible to hold time-series target acceleration values (an acceleration change pattern) of the vehicle, and perform intervention control of the vehicle based on the time-series target acceleration value.

The invention has been described with reference to example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

1. A drive assist system comprising:
an acceleration change pattern setting portion that sets an acceleration change pattern of a vehicle that is a pattern of change in acceleration of the vehicle that occurs while the vehicle travels on a road; and
a drive plan generating portion that generates a drive plan for the vehicle based on the acceleration change pattern set by the acceleration change pattern setting portion.

2. The drive assist system according to claim 1, further comprising a passing point setting portion that sets a passing point of the vehicle on the road,
wherein the drive plan generating portion generates the drive plan for the vehicle based on the acceleration change pattern set by the acceleration change pattern setting portion and the passing point set by the passing point setting portion.

3. The drive assist system according to claim 1, wherein
the acceleration change pattern setting portion sets a plurality of the acceleration change patterns for sections of the road respectively, and selects one of the plurality of the acceleration change patterns based on a driving condition of the vehicle on a preceding one of the sections of the road.

4. The drive assist system according to claim 1, wherein
the acceleration change pattern setting portion sets the acceleration change pattern according to a kinetic property of the vehicle.

5. The drive assist system according to claim 4, wherein
the acceleration change pattern setting portion sets the acceleration change pattern such that a rate of change in acceleration decreases as an absolute value of the acceleration increases.

6. The drive assist system according to claim 4, wherein
the acceleration change pattern setting portion sets the acceleration change pattern such that a rate of change in acceleration in a turning direction is small at a start of occurrence of the acceleration in the turning direction.

7. A drive assist system configured to hold time-series acceleration values of a vehicle and provide drive assist for the vehicle based on the time-series acceleration values.

8. A drive assist method comprising:
setting an acceleration change pattern of a vehicle that is a pattern of change in acceleration of the vehicle that occurs while the vehicle travels on a road; and
generating a drive plan for the vehicle based on the set acceleration change pattern.

9. The drive assist method according to claim 8, further comprising setting a passing point of the vehicle on the road,
wherein the drive plan for the vehicle is generated based on the set acceleration change pattern and the set passing point.

10. The drive assist method according to claim 8, wherein
in setting the acceleration change pattern, a plurality of acceleration change patterns are set for sections of the road respectively and one of the plurality of the acceleration change patterns is selected based on a driving condition of the vehicle on a preceding one of the sections of the road.

11. The drive assist method according to claim 8, wherein
the acceleration change pattern is set according to a kinetic property of the vehicle.

12. The drive assist method according to claim 11, wherein
the acceleration change pattern is set such that a rate of change in acceleration decreases as an absolute value of the acceleration increases.

13. The drive assist method according to claim 11, wherein
the acceleration change pattern is set such that a rate of change in acceleration in a turning direction is small at a start of occurrence of the acceleration in the turning direction.

14. A drive assist method comprising
holding time-series acceleration values of a vehicle; and
providing drive assist for the vehicle based on the time-series acceleration values.
